(19) United States
(12) Patent Application Publication
(10) Pub. No.: US 2006/0212304 A1
(43) Pub. Date: Sep. 21, 2006

(54) Automated item forwarding system and method

(76) Inventor: Matthias Krause, Orsingen-Nenzingen (DE)

Correspondence Address: Philip G. Meyers;Intellectual Property Law, P.C., #300, 1009 Long Prarie Road, Flower Mound, TX, 75028, US

(21) Appl. No.: 11/128,977

(22) Filed: May 13, 2005

Related U.S. Application Data
(60) Provisional application No. 60/663,658, filed on Mar. 21, 2005.

(51) Int. Cl. G06Q 99/00

(52) U.S. Cl. 705/1

(57) ABSTRACT

Rental items are directly forwarded from customer to custom using a method whereby a supplier's computer communicates with a postal computer via an electronic link when an item identified with a unique machine readable code is returned by a customer to the postal service and identified with the code, the supplier computer's accessing a customer database including customer orders and address information corresponding to the customer orders and selecting the next customer to receive the item then transmitting the address of the next customer to the postal computer for forwarding to the next customer.

This application claims priority of U.S. Provisional Ser. No. 60/663,658, filed Mar. 21, 2005.

### TECHNICAL FIELD

The present invention relates to an automated system and method of forwarding items delivered by postal services and in particular, to automated forwarding of rented items from customer to customer.

### BACKGROUND OF THE INVENTION

There is a growing trend in the United States and elsewhere to rent items for limited time use by telephone, through the mail or over the Internet. Such items include movies and music recorded on VHS tape media, digital compact disks (DVD), audio books, text books and similar items. In one popular rental scheme, a rental customer pays a rental company a fixed monthly fee to rent, for example, movies recorded on DVD media. The customer selects a fixed number of such DVDs which are delivered to the customer via a postal service such as USPS. The customer views the movies and then returns the DVDs to the rental company using a postage prepaid return envelope furnished by the rental company. After the rental company receives the DVDs, the customer's account is updated and the customer is then entitled to select more DVDs for delivery and viewing. In each case, however, the DVDs must be returned to the rental company via the postal service before the customer is allowed to rent additional items and before the item can be made available to the next customer. If the rental item could be forwarded from a rental customer to the next customer without returning the item to the rental company, the availability and utilization of the rental item would increase and the amount and cost of handling required would decrease. Furthermore, the technology to accomplish customer-to-customer forwarding of rental items is available.

Modern postal services, for example, the U.S. Postal Service, utilize automated handling and sorting equipment to facilitate the sorting, processing and distribution of millions of mail pieces on a daily basis. Computerized sorting systems utilize bar code scanners and optical character recognition (OCR) technology to recognize addresses or codes placed on mail pieces and employ printers and labeling systems for printing address labels and/or bar-code formatted ZIP codes (or similar codes) on envelopes or on labels applied to mail pieces to enable further automated processing. Typically, the mail pieces are coded and sorted according to a sort scheme into numerous groups (e.g., a range of ZIP codes, ZIP code (5 digits), ZIP code (9 digits), etc.) that allow for efficient distribution and delivery of the mail. Further, automated systems and methods are available to identify mail incorrectly addressed to a recipient at a former address and redirect the mail to the recipient's current address. One such system and method is disclosed in Allen et al., U.S. Pat. No. 5,422,821 issued Jun. 6, 1995 for an “Apparatus for Intercepting and Forwarding Incorrectly Addressed Postal Mail.”

### SUMMARY OF THE INVENTION

In accordance with the invention, items are directly forwarded from a first customer for the item to a second customer for the item. The items are first deposited by a supplier, such as a rental company, with the postal service for delivery to the first customer. The first customer is also directed to return the items to the postal service when the customer is either finished with the item or at the expiration of the rental period. The postal service is then directed, upon return of the item by the first customer, to forward the item directly to the second customer.

The invention provides a method for customer-to-customer forwarding of rental items including the steps of: a) having a first renter deposit the rental item for delivery in the postal system, b) reading an indicia on the deposited rental item, c) comparing the read indicia to a computerized list of forwarding delivery destinations, including delivery destinations for subsequent renters, which list includes an entry corresponding to the indicia, d) determining a forwarding delivery destination for the rental item which corresponds to the entry on the list, e) correcting the delivery destination for the rental item which corresponds to the entry on the list, and f) forwarding the rental item to the forwarding delivery destination from a general mail facility.

The invention also provides a method of utilizing a postal service to forward an item for sequential use by more than one customer including the steps of: a) depositing the item with the postal service for forwarding to the first customer, b) receiving a signal from the postal service, the signal including a code identifying the rental item, c) comparing the code to entries in a computer-seachable database including a computerized list of customer orders for the item, d) selecting a customer order from the list, and e) transmitting a message to the postal service to forward the item to an address corresponding to the selected customer order. In order to facilitate identification of the item by the postal service, one or both of the item and a package in which the item is forwarded with a machine-readable indicia, the machine-readable indicia representing a code identifying the item.

The invention additionally provides a method of forwarding a rental item from a first renter of the item to a second renter of the item using automated lock boxes located at each renter's residence or place of business, or at a common location. The first renter deposits the rental item in a first automated lock box after the first renter's use of the rental item is concluded. The rental item is then transported, such as by a private courier service, from the first lock box to a second automated lock box at which the second renter can retrieve the item. If the first lock box is at a common location and the second renter is in the same local area as the first renter, then the transport step could be omitted and the second renter would open the same lock box that the first renter returned the item to. These and other variations of the invention are set forth in the detailed description that follows.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic representation illustrating a current rental system utilizing the USPS for delivery and return of rental items;

FIG. 2 is a front view of a return envelope suitable for use in the practice of the present invention;

FIG. 3 is a front view of the return envelope of FIG. 2 with a customer address label applied;

FIG. 4 is a side view of the return envelope of FIG. 2;

FIG. 5 is a schematic representation illustrating a rental system according to the invention utilizing the USPS for delivery and forwarding of rental items;

FIG. 6 is a schematic representation of entries in an order table for use in the practice of the invention;

FIG. 7 is a schematic representation illustrating an alternative rental system according to the invention utilizing a lock box system for delivery and forwarding of rental items; and

FIG. 8 is a schematic representation illustrating a second alternative rental system according to the invention utilizing private lock boxes and a private courier for delivery and forwarding of rental items.

### DETAILED DESCRIPTION OF THE INVENTION

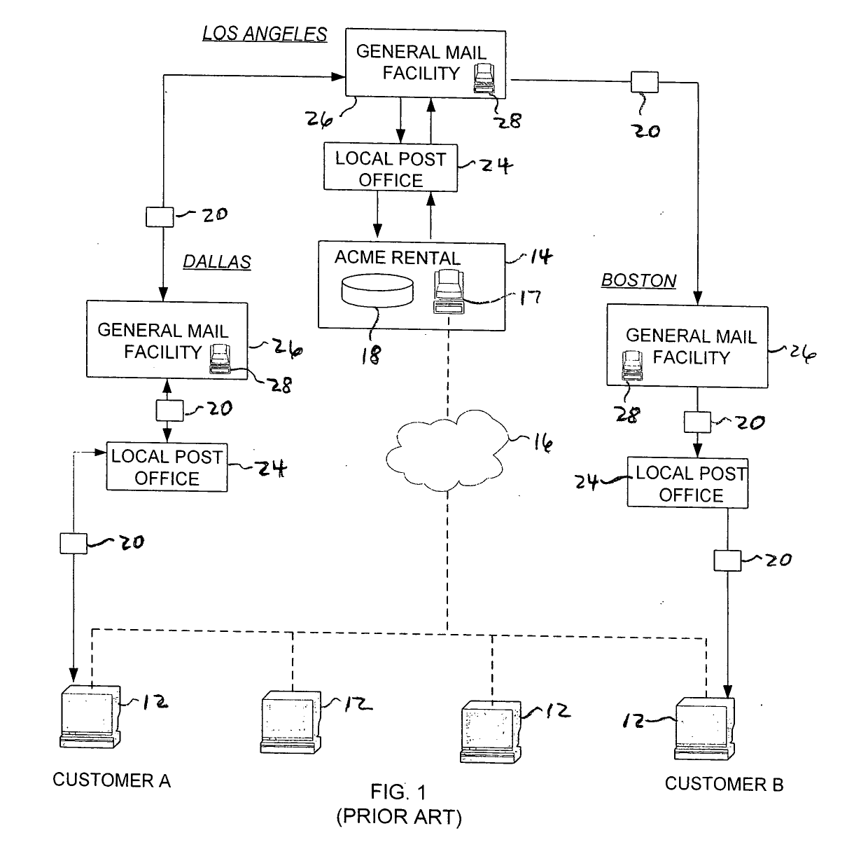

Referring now to FIG. 1, in a current rental system, customer A, located in the Dallas area utilizes a personal computer 12 to place order with a rental company 14, located in the Los Angeles area via the Internet 16. Upon receiving the order, rental company 14 checks the customer's account status with computer 17 including database 18 to insure that the customer is entitled to rent the ordered item or items, e.g., that the customer's account is current and that items previously rented by customer A have been returned. Assuming that customer A is entitled to rent item 20 and the item is in inventory at rental company 14, item 20 is packaged and/or labeled with customer A's address. Item 20 is then delivered to the local post office 24 serving the rental company for forwarding to customer A along with a return envelope addressed to the rental company.

Item 20 is forwarded to the General Mail Facility (GMF) 26 serving the Los Angeles area where rental company 14 is located. Item 20 is scanned using a bar code reader and/or an OCR scanner to determine the delivery point zip code for the destination address appearing on item 20. The scanned address information is input into one or more computers 28 at GMF 26 which control the sorting processes for mail received at the GMF. Based on the scanned destination information, item 20 is sorted for delivery to GMF 26 serving the Dallas area where customer A resides. When item 20 is received at serving the Dallas area, the item is sorted, along with other mail received at GMF 26, to the various local post offices 24 in the region. Once item 20 is received at the local post office 24 serving Customer A, it is delivered by the carrier serving the route on which customer A lives.

When customer A wishes to return the item, he or she places item 20 in the return envelope provided by rental company 14 and deposits the item in a mail drop box or drops the item off at a local post office 24. Item 20 is then returned to rental company 14 via the GMFs 26 serving the Dallas and Los Angeles areas and the local post office 24 serving the rental company. Upon receipt of item 20 from local post office 24, rental company 14 updates customer A's account to reflect the return of the item, after which item 20 is available to be rented to customer B who resides in the Boston area and has placed an order for item 20. Rental company 14 packages and/or labels item 20 with customer B's address and delivers the item to local post office 24 after which the item is successively forwarded to the GMF 26 serving the Los Angeles area, the GMF 26 serving the Boston area and to the local post office serving customer B for carrier delivery to the customer.

The foregoing system is inherently inefficient in that rental item 20 must return to rental company 14 after each rental, reducing the utilization of rental item 20 since it is unavailable for rental while in transit back and forth to rental company 14. In accordance with the invention, utilization of rental items transmitted by mail is maximized with a customer-to-customer forwarding method that utilizes a suitable return envelope, scanning and labeling equipment located at General Mail Facilities 26 and through the implementation of a communications system linking computers located at the rental company and the General Mail Facilities.

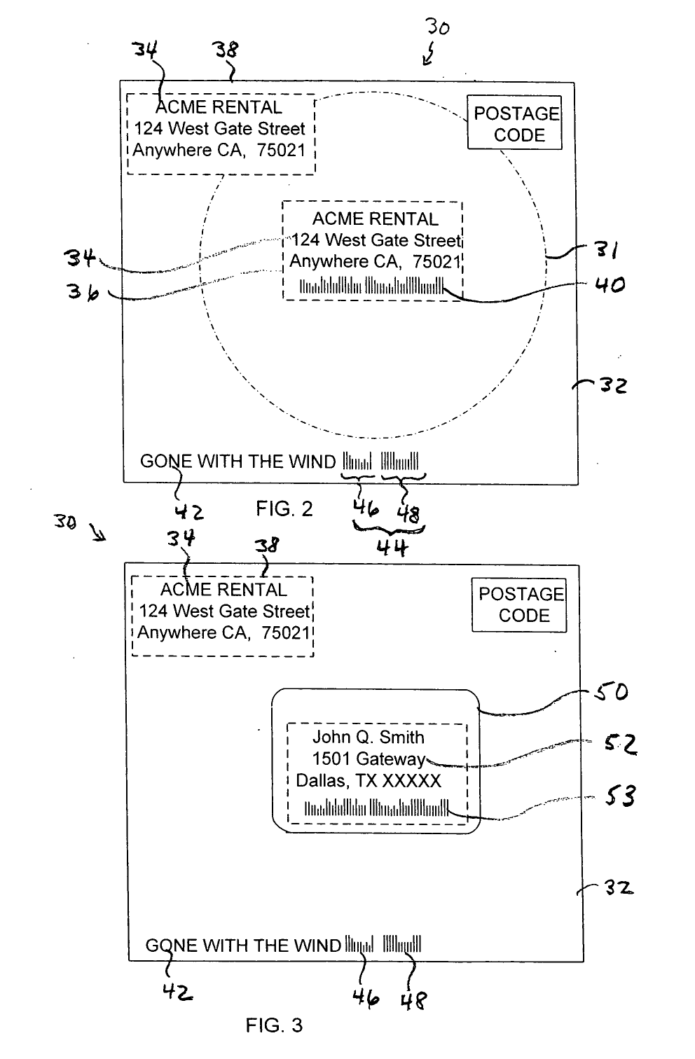

Turning to FIGS. 2-4, a DVD return envelope 30 suitable for customer-to-customer forwarding of a rental DVD 31 is provided with a cover 32 having the rental company's address 34 imprinted in address block 36 and in return address block 38. As illustrated, a PostNet delivery code 40 corresponding to the delivery address of rental company 14 appears adjacent the bottom of address block 36. Preferably, address 34 is permanently imprinted on cover 32 in address block 36 and return address block 38 or, if cover 32 is transparent, on a substrate beneath the cover.

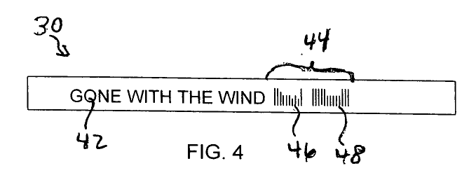

Also imprinted on return envelope 30 is an item name 42, which in the illustrated example is the title of a movie, Gone With the Wind, recorded on DVD 31 stored in return envelope 30. Adjacent item name 42 is a two-part machine readable identification code 44 including an item name code 46 and a unique item number code 48 that identifies the specific item. As used herein, “machine readable” includes text that may be scanned and interpreted with OCR technology as well as bar codes, magnetic codes and similar codes. As best illustrated in FIG. 4, the title of the movie and identification code 44 are also imprinted on the side of return envelope 30 to facilitate scanning the title and identification code with a bar code or OCR scanner.

In the case of fungible items such as books, DVDs or VHS tapes, first portion 46 of item identification code 44 identifies the title or type of the rental item and second portion 46 that identifies the specific item. Thus, in the illustrated example, item name code 46 corresponds to a recording of Gone With the Wind on DVD 31. Item number code 48 identifies the specific DVD. For example, if rental company 14 has ten copies of Gone With the Wind in inventory, item number 48 would signify, for example, that copy number eight of the ten copies was contained in the return envelope.

Referring to FIG. 3, return envelope 30 has been labeled for delivery to a customer with a label 50 applied over the address 34 of rental company 14. Preferably, label 50 is peelable, so it can be readily removed from return envelope 30 by the customer. As illustrated, the label includes the customers address 52, including a PostNet code 53 corresponding to the customer's five, nine or 11 digit Zip code.

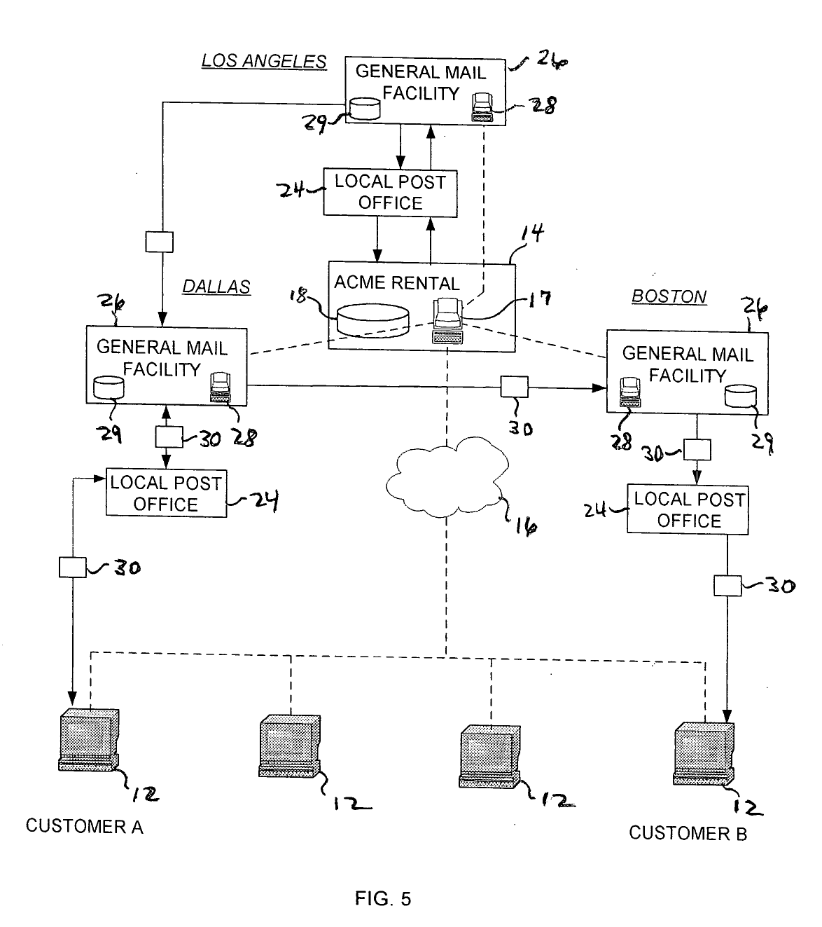

Referring now to FIG. 5, in a method according to the invention, rental company 14 receives and processes an Internet based order from customer A for an item such as DVD 31 using computer 17 that accesses customer A's file in account data base 18 to verify that the customer is entitled to rent DVD 31. After verifying the status of customer A's account, computer 17 transmits the customer's name and address to a printer which prints mailing label 50 (FIG. 3) with the customer's name and address 52, including the post net code 53 for the particular customer. Label 50 is then applied to return envelope 30 in address block 36, covering the rental company address 34. Return envelope 30, containing DVD 31 is then delivered to the local post office 24 for forwarding to customer A as described in connection with FIG. 1. Computer 17 updates the customer's file in data base 18 to indicate that DVD 31 has been forwarded to customer A and updates a product data file to show the status of DVD 31 as rented to customer A.

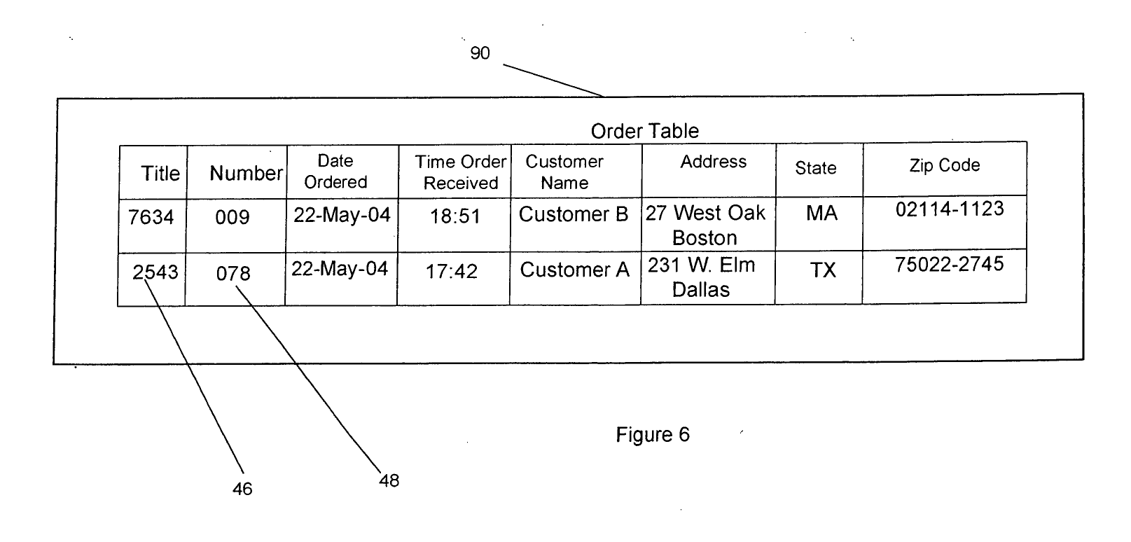

When customer A is finished with DVD 31, he or she places the DVD in return envelope 30 and removes label 50 from return envelope 30, exposing address 34 of rental company 14. Customer A then deposits return envelope 30 at the local post office 24 from which it is forwarded to the GMF 26 serving the Dallas area. Return envelope 30 is scanned for address information and for item code 44 using conventional bar code or OCR scanning techniques and equipment such as IOSS (Input/Output Subsystem for Remote Bar Code System) at the GMF 26 serving the Dallas area. The results of the bar code scan or the OCR analysis of an image of return envelope 30 are transmitted to postal computer 28 at GMF 26. Computer 28 compares code 44 to a database of codes provided by rental companies and maintained on a data storage device 29 (FIG. 6) for rental items belonging to the rental companies, including rental company 14. Computer 28 identifies code 44 as identifying copy number eight of a DVD recording of Gone With the Wind 31 belonging to rental company 14. Postal computer 28 then signals the sorter handling return envelope 30 to divert the return envelope for separate processing. If no identification code is identified, the mail piece is passed for standard sorting and processing.

Alternatively, computer 28 may use both the address or part of the address of rental company 14 along with code 44 to identify return envelope 30. In this case, the database maintained on data storage device 29 at GMF 26 would be structured to include the names of participating rental companies utilizing the customer-to-customer forwarding system and codes identifying individual rental items. Computer 28 would first compare, for example, the PostNet delivery code for rental company 14 with a list of PostNet delivery codes for participating rental companies. If a match was found, computer 28 would then compare code 44 with a list of codes maintained in the database for rental items belonging to rental company 14.

If an identification code is detected and matched, return envelope 30 is, if necessary, placed in a temporary delay while postal computer 28 queries rental company computer 17 to determine whether an order is pending. The query may be transmitted via the Internet, a wide area network, a dedicate hardwired or radio frequency link or a similar means. In one embodiment, the query may consist of the item identification code 44 and a code identifying GMF 26. Rental company computer 17 checks for pending orders for DVD 31 in database 18. If an order is pending, for example from customer B, rental company computer 17 transmits the customer's name and address data to postal computer 28 at GMF 26. If no order is pending, computer 17 replies with a code directing computer 28 to return return envelope 30 to the mail stream to be sorted for return to rental company 14.

Upon receiving customer B's name and address, computer 28 directs a printer to print a label bearing customer B's address which is applied to return envelope 30 in address block 36 over address 34 of rental company 14. Computer 28 also debits a postage account maintained by rental company 14 for the postage required to forward DVD 31 to customer B and for any processing fees and transmits a confirmation signal to rental company computer 17. Upon receiving the confirmation signal from computer 28, rental company computer 17 updates database 18 to reflect that customer B's order has been filled and that DVD 31 has been forwarded to customer B.

After return envelope 30 has been labeled with customer B's name and address, the return envelope is then returned to the mail processing stream and sorted for delivery to GMF 26 in the Boston area. Upon arrival at GMF 26 serving the Boston area, return envelope 30 is sorted for delivery to the local post office 24 serving customer B, after which a local carrier delivers return envelope 30 to customer B's address.

In accordance with the foregoing method, it is possible for rental company 14 to dispense with labeling return envelopes 30. Rather, the rental company may, in response to an order from customer A, simply deposit return envelope 30 at local post office 24. When return envelope 30 is received at GMF 26, the return envelope is scanned and identified as described above. When computer 28 queries rental company computer 17, customer A's order will be identified and rental company computer 17 will respond to the inquiry with customer A's name and address. Postal computer 28 will then direct a printer to print a label bearing customer A's address which is applied to return envelope 30 in address block 36 over address 34 of rental company 14. After labeling, return envelope 30 is returned to mail stream and forwarded to customer A. When customer A is finished with DVD 31, he or she removes the label and deposits return envelope 31 with local post office 24, after which the return envelope is processed as described above. Depending upon the demand for DVD 31, rental company 14 may elect to periodically deposit return envelopes 30 with DVD 31 with local post office 24 to meet anticipated demand rather than in response to orders from specific customers.

In one variation of the method, customer A is not required to remove label 50 from return envelope 30. Rather, customer A deposits return envelope 30 with local post office 24 with label 50 bearing his or her address still in place. At GMF 26 identification code 44 is recognized when return envelope 30 is scanned, identifying return envelope 30 as containing copy number eight of a DVD recording of Gone With the Wind 31 belonging to rental company 14. Postal computer 28 then checks a counter, maintained on computer 28 at GMF 26 or on computer 17 at rental company 14. If the counter indicates that the return envelope is being sent to a customer, i.e., the counter register indicates zero or an even number, the return envelope is returned to the mail stream and the counter is incremented by one.

If the counter indicates that return envelope 30 is being returned, i.e., the counter registers an odd number, computer 28 queries rental company computer 17 to check pending orders for DVD 31. In one application, rental company 14 maintains a queue of orders from its customers for the particular movie title on a first, first served basis. Thus, for example, if customer B is at the top of the queue for DVD 31, rental company computer 17 transmits customer's B's name and address data to computer 28 at GMF 26 and records that DVD 31 has been forwarded to customer B. Computer 28 then increments the counter and directs a printer to print a label bearing the customer address which is applied to return envelope 30 over the label bearing customer A's address. The return envelope is returned to the mail stream for forwarding to the customer. When customer B is done with DVD 31, he or she places the DVD in return envelope 30 and deposits the return envelope with local post office 24, after which the process may be repeated any number of times.

If no order is pending for DVD 31, computer 17 replies with a code directing computer 28 to label return envelope 30 with the address of rental company 14. After labeling, return envelope 30 is returned to the mail stream to be sorted for return to the rental company.

Turning now to FIG. 6, an example of an order table 90 maintained in database 18 at rental company 14 includes numerical entries corresponding to first and second portions 46, 48 of item identification code 44 that identify the title or name of the item ordered, the unique item number, the date and time the order was placed, the name of the customer that placed the order, and the customer's address information. The table is updated using a first in-first out scheme that results in orders being filled in the sequence in which the orders were received.

Numerous variations of the foregoing method are possible. For example, to reduce processing time at GMF's 26, the database containing customer orders may be maintained on one or more data storage devices 29 at GMF's 26 and periodically updated by rental company computer 17. This process may be preferable where a removable label is used such that the “default” address is that of the rental company.

In another embodiment, computer 28 at GMF 26 may be programmed to identify and divert all mail pieces directed to rental company 14 based upon the rental company's address data, particularly the PostNet delivery code associated with the rental company, rather than identification number 44. In this variation, the mail pieces are segregated based on the address information obtained when mail pieces are scanned at GMF 26 then processed with a second scan to identify and segregate those mail pieces having an identification code. After the second scan, mail pieces with an identification code are used to fill pending orders as described above. Mail pieces addressed to rental company 14 without an identification code are returned to the mail stream for sorting and delivery to the rental company.

In another variation, rental company 14 may accumulate a series or list of orders for an item, for example, orders for a movie placed by customers before the movie is released on DVD media for rental. When the movie is released, rental company 14 provides the postal service with one or more copies of the movie recorded on a DVD 31 along with a list of customers that have ordered the movie. A unique customer list may be provided or associated with each individual DVD 31 in order to prevent DVD 31 from being sent to the same customer more than once. For example the first copy is assigned to customers with last names beginning with the letters A-D, the second copy to customers with last names beginning with E-H and continuing for all customers that placed orders for the movie.

When the movie is released, the list or lists are forwarded to computers 28 at GMFs 26 and return envelopes 30 with DVDs 31 are deposited in the mail by rental company 14 with no address label or labeled with the address of rental company 14. At GMF 26 identification code 44 for each DVD 31 is recognized when return envelope 30 is scanned, identifying return envelope 30 as containing a particular copy of the recorded movie. Postal computer 28 then checks the list of customers supplied by rental company 14 for the particular copy and directs a printer to print a label with the address of the next customer on the list. Return envelope 30 is labeled with the customer address and returned to the mail stream for forwarding to the customer. Computer 28 also updates the list to indicate that the DVD has been forwarded to that particular customer. When the customer returns the DVD, the process is repeated until all customers on the list have received the DVD, after which return envelope 30 is returned to rental company 14.

In another embodiment, rental company computer 17 may be programmed to prioritize orders based on criteria other than the sequence in which orders are placed. For example, computer 17 may be programmed to fill an order from a customer residing in the same GMF 26 area where the rental item is identified before filling orders requiring shipment of the item to more remote locations, regardless of when the orders were received. Numerous variations for prioritizing orders to minimize postal rates, maximize utilization and reduce customer waiting lists are possible.

Depending upon the particular type of rental item, rental company 14 may enter into and agreement with a postal service to hold rental items at GMF 26 in the event that there are no pending orders for the item. Such items would be identified, segregated and stored in a bin or other receptacle for manual or automated retrieval. A list of the stored rental items would be maintained in a data base on data storage device 29. When rental company 14 receives an order for the item, computer 17 would transmit the address of the customer that placed the order to postal computer 28, which would signal an operator or automated retrieval system to retrieve, address and forward the item to the next customer. Alternatively, the items may be held in a bin or receptacle for a predetermined period, for example twenty four hours, then added back into the incoming mail stream. If orders for the item or items had been placed within the predetermined period, the items would be used to fill pending orders as described above.

The foregoing methods are particularly applicable to fungible goods whereby the next available rental item is forwarded directly from one customer to the next customer in line to receive the item. An alternative method may be more suitable for use in connection with unique items, where only one of such items is available for rental or where the rental company has a strict limit on the amount of time that a customer may keep a particular item. In this embodiment, communication between computer 17 of rental company 14 and postal computer 28 is reversed. When customer B orders an item in the possession of customer A, computer 17 of rental company A transmits customer B's name and address along with the item's identification code 44 to computers 28 at GMF's 26 which store the information. Thus, when return envelope 30 is received and scanned at GMF 26, there is no need for computer 28 to query computer 17 of rental company 14 since the forwarding destination information is already available. As soon as the rental item is identified, the item is labeled with customer B's address and forwarded. Computer 28 also transmits a message to computer 17, notifying rental company 14 that the item has been forwarded to customer B. Computer 17 then updates database 18 to reflect that the item has been returned from customer A and forwarded to customer B.

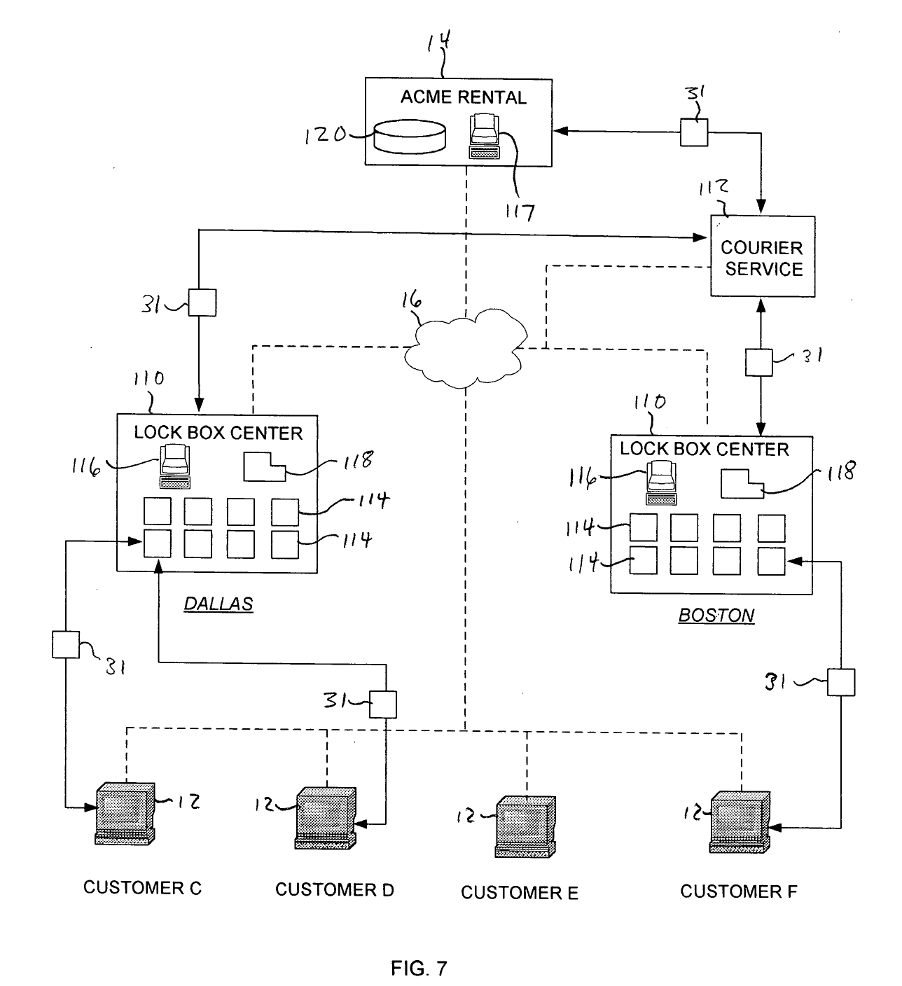

Turning to FIG. 7, in another variation, customer-to-customer circulation of DVDs 31 or similar rental items may be accomplished utilizing a system including a plurality of automated lock box centers 110 and a private courier service 112. Each of lock box centers 110 includes a plurality of automated lock boxes 114 controlled by a computer 116 and a bar code or similar scanner 118. Computer 116 communicates with computer 117 of rental company 14 via the Internet 16, or alternatively via a private network or a hardwired connection. Lock box centers 110 are preferably located in convenient, easily accessible locations such as grocery stores or shopping centers. Customers transmit rental orders to rental company 14 using personal computers 12 to communicate with a central computer 117 at rental company 14. A computer-searchable database 120 is used to store customer account information, pending orders, inventory location and other information necessary to implement the method described herein.

Customer C, located in the Dallas area, orders a DVD 31 and picks it up at the local lock box center 110 upon receipt of a notice of arrival sent by email or other means. When customer C is done viewing DVD 31, the customer returns the DVD to the local lock box center 110 and scans a code such as item identification code 44 (FIG. 2) appearing on the DVD or the case used to hold the DVD. After DVD 31 is scanned, computer 116 activates the locking mechanism of one of lock boxes 114, unlocking the box and enabling customer C to place the DVD in the lock box. Computer 116 then transmits a signal to computer 117 indicating that DVD 31 has been returned and also the identification number of the particular lock box 114 where the DVD is located. Computer 117 then updates customer C's account and stores the identification number of the particular lock box where the DVD is located in database 120.

If rental company 14 has, or receives, an order for the particular DVD 31 from customer D, also located in the Dallas area, computer 117 checks database 120 to determine the location of available copies of the particular DVD. In this example, computer 117 locates the copy of DVD 31 that customer C has just returned to lock box center 110 in Dallas. After verifying customer D's account information, computer 117 transmits a message via the Internet to customer D with the identification number of the lock box 114 where DVD 31 is located along with a unique access code that enables D to access the lock box. To obtain DVD 31, customer D then goes to lock box center 110 and enters the access code utilizing a keypad or similar device. Computer 116 then unlocks the box, enabling customer D to remove the DVD. Computer 116 transmits a signal to computer 117 indicating that customer D has taken possession of DVD 31. The access code is reset by computer 116 for security purposes and transmitted to computer 117 which updates database 120 to indicate that customer D is now in possession of DVD 31.

If a copy of the particular DVD 31 that customer D wishes to rent is not in one of lock boxes 114 of the Dallas area lock box center 110, computer 117 searches database 120 to determine the location of other available copies. If a copy of the desired DVD 31 is located in the Boston area lock box center 110, computer 117 transmits a message to courier service 112, directing the service to retrieve DVD 31 from the Boston Area lock box center 110 and forward it to the Dallas area lock box center 110. When DVD 31 arrives in Dallas, a delivery person for courier service 112 delivers the DVD to lock box center 110 and scans the DVD. Computer 116 opens a selected lock box 114, allowing the delivery person to place DVD 31 in the lock box 114. Computer 116 at the Dallas area lock box center 110 then notifies computer 117 that DVD 31 is in lock box 114, after which computer 117 transmits a message to customer D with the lock box identification number and access code. In the event that a copy of DVD 31 is not available at one of lock box centers 110, computer 117 will direct courier service 112 to obtain the DVD directly from rental company 14 and forward the DVD to lock box center 110 in the Dallas area.

Computer 117 is also provided with inventory control program logic to control the geographic distribution of DVDs 31. For example, if excess copies of a particular DVD 31 are located at the Dallas lock box center 110, computer 117 will direct courier service 112 to collect copies of the DVDs 31 from Dallas center 110 and redistribute the DVDs 31 to other centers 110. Similarly, if all of the lock boxes 114 at Dallas lock box center 110 are in use, computer 117 will direct courier service 112 to collect selected DVDs from center 110 in order to empty sufficient lock boxes for customer use. DVDs 31 removed from lock boxes 114 at the center may be stored at lock box center 110, by courier service 112 or returned to rental company 14. In any case, computer 117 updates database 120 to reflect the location of the DVDs removed from lock boxes 114 by courier service 112.

Numerous variation are possible. Computers 116 could be networked and provided with program logic to perform some or all of the functions of computer 117. As an alternative to transmitting a code to a customer each time the customer wishes to rent a DVD, each customer could be provided with a magnetically encoded identification device such as a card. Then, when a customer orders DVD 31, computer 117 transmits a signal to the customer with the identification number of the lock box where the DVD is located. Computer 117 also transmits a signal to computer 116 directing the computer to open the particular lock box where DVD 31 is located when the customer's identification device is read using a device such as a magnetic card reader.

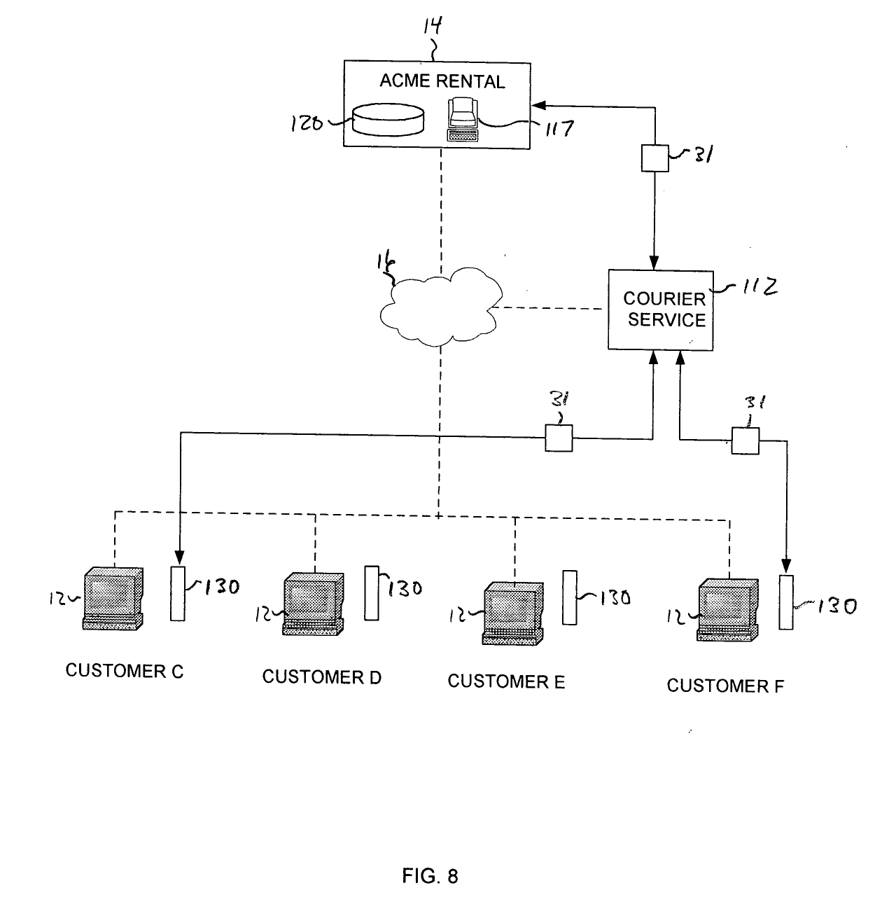

Turning to FIG. 8, in another variation, rental company 14 utilizes courier service 112 to deliver DVDs 31 to individual, private lock boxes 130. See Porter U.S. Pat. No. 5,774,053, issued Jun. 30, 1998, the contents of which are incorporated by reference herein for an example of a private lock box. In this variation, it is anticipated that courier service 112 will store an inventory of at least the most popular DVDs 31 at a local office or storage center in order to expedite delivery to customers. In this case, the number of titles of DVDs 31 stored locally is controlled by computer 117 in accordance with a programed distribution scheme.

When a customer wishes to rent a DVD 31, he or she uses personal computer 12 to place an order via the Internet 16 with rental company 14. Computer 117 receives and processes the order and transmits a message with the order to courier service 112 which delivers the DVD to the customer's private lock box 130. Private lock boxes 130 may be located at the customer's residence, office or other convenient location. The delivery person accesses and opens each customer's lock box 130 with a master key, code or magnetically encoded identification device to open the box. Computer 117 sends a message to the customer notifying the customer that DVD 31 has been delivered to the customer's lock box. The customer accesses his or her lock box 130 with a personal identification code, a magnetically encoded card or similar device to retrieve DVD 31. When the customer is finished with DVD 31, he or she replaces the DVD in lock box 130 and transmits a message to rental company 14 indicating the DVD has been placed in his or her lock box for pickup. Computer 117 then transmits a message to courier service 112 to pick up the DVD from the customer.

In order to track the DVDs 31 each time a delivery person for courier service 112 delivers or picks up a DVD, he or she scans both the DVD and a bar or similar code 124 located on or in the private lock box 122 with a hand held scanner. At the end of the delivery person's route or day, the data from the handheld device is downloaded and transmitted to computer 117 at rental company 14. The information is used to update database 120 whereby rental company 14 can readily track its inventory of DVDs 31, determine which customers have received and returned DVDs 31 and notify customers when a DVD has been delivered to his or her personal lock box 130. Alternatively, the delivery person may manually record the identification number of DVDs 31 that he or she delivers and picks up, after which the information is manually entered with a keyboard or similar device and transmitted to computer 117.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. Thus, while the invention has been described in connection with computers and data storage devices at various locations, these devices may be centralized at a single location or distributed to other locations, depending on the location and availability of such devices. Similarly, one or more of databases referred to herein may be combined on a single data storage device or distributed among multiple devices. The methods described herein using a federal postal service may, in some instances, be implemented using private delivery services. All such variations and additions are specifically contemplated to be with the scope of the invention. It is, therefore, intended that the appended claims encompass any such modifications or embodiments.

We claim:

1. A method of forwarding a rental item from a first renter of the item to a second renter of the item using a postal system wherein mail pieces are collected and shipped between a number of general mail facilities each corresponding to a geographical area in which mail is deposited for delivery and from which mail is shipped for delivery to recipient addresses served by each general mail facility comprising the steps of:
a) having the first renter deposit the rental item for delivery in the postal system;
b) reading an indicia on the deposited rental item;
c) comparing the read indicia to a computerized list of forwarding delivery destinations, which list includes an entry corresponding to the indicia;
d) determining a forwarding delivery destination for the rental item which corresponds to the entry on the list;
e) correcting the delivery destination for the rental item which corresponds to the entry on the list; and
f) forwarding the rental item to the forwarding delivery destination from a general mail facility.

2. The method of claim 1 wherein the step of reading an indicia on the deposited rental item comprises scanning the rental item in an automated sorting machine.

3. The method of claim 1 wherein the step of correcting the delivery destination for the rental item which corresponds to the entry on the list comprises labeling the rental item with a forwarding address.

4. The method of claim 1 wherein the step of correcting the delivery destination for the rental item which corresponds to the entry on the list comprises printing the forwarding address directly on the rental item.

5. The method of claim 1 wherein the rental item comprises a media recording.

6. The method of claim 5 wherein the media is one of a DVD and videotape.

7. The method of claim 1 further comprising:
prior to step b), scanning and decoding addresses printed on mail pieces processed at the general mail facility;
identifying mail pieces addressed to a rental company; and
separating items addressed to the rental company from the remainder of the mail being processed at the general mail facility.

8. A method of utilizing a postal service to forward an item for use by multiple customers that receive the item sequentially, comprising:
a) depositing the item with the postal service for forwarding to a customer;
b) receiving a signal from the postal service, the signal including a code identifying the rental item;
c) comparing the code to entries in a computer-seachable database including a computerized list of customer orders for the item;
d) selecting a customer order from the list; and
e) transmitting a message to the postal service to forward the item to an address corresponding to the selected customer order.

9. The method of claim 8 further comprising the step of labeling one or both of the item and a package in which the item is forwarded with a machine-readable indicia, the machine-readable indicia representing a code identifying the item.

10. The method of claim 8 wherein step d) further comprises transmitting a delivery destination for the item corresponding to the selected customer order to the postal service.

11. The method of claim 9 further comprising recording in the database that the item has been sent to the selected customer.

12. The method of claim 8 wherein the customer is selected from the list based upon the sequence in which orders for the item were received.

13. The method of claim 8 wherein the customer is selected from the list based upon the geographic area in which the customer lives.

14. The method of claim 8 wherein the signal is received from one or a plurality of general mail facilities corresponding to geographical areas in which mail is deposited for delivery and from which mail is shipped for delivery to recipient addresses served by each general mail facility.

15. A method of forwarding an item from a first customer to a second customer using a postal service, comprising the steps of:
a) depositing the item with the postal service for forwarding to the first customer;
b) directing the first customer to return the item to the postal service; and
c) directing the postal service to forward the item directly to the address of the second customer when the item is returned to the postal service by the first customer.

16. The method of claim 15 further comprising the step of utilizing a computer to communicate with one or more postal computers maintained by the postal service to provide the postal service with the address of the second customer.

17. The method of claim 16 further comprising receiving an electronic communication from the postal service, the electronic communication including a code identifying the rental item.

18. The method of claim 17 further comprising the step of maintaining a database including customer address information and customer orders.

19. The method of claim 18 further comprising recording in the database that the item has been sent to the second customer.

20. The method of claim 15 further comprising labeling one or both of the item and a package in which the item is forwarded with a machine-readable indicia, the machine-readable indicia representing a code identifying the item.

21. A method of forwarding a rental item from a first renter of the item to a second renter of the item comprising:
providing a numbered, automated lock box wherein the first renter deposits the rental item;
transmitting a signal to a computer indicating that the rental item has been placed in the lock box, the signal including a code identifying the rental item;
updating a computer-searchable database to indicate the number of the lock box where the rental item is located;
transmitting a message to the second renter, the message including the number of the lock box;
opening the lock box when the second renter provides an access code.

22. The method of claim 21, further comprising activating the numbered, automated lock box such that the lock box is opened when the box when the first renter scans the rental item with a scanner.

23. The method of claim 21, further comprising recording in a computer-searchable database that the second renter is in possession of he rental item.

24. The method of claim 21, wherein the message transmitted to the second renter includes the access code for the lock box.

25. A method of forwarding a rental item from a first renter of the item to a second renter of the item comprising:
providing a first automated lock box wherein the first renter deposits the rental item after the first renter's use of the rental item is concluded; and
transporting the rental item from the first lock box to a second automated lock box at which the second renter can retrieve the item.
